(19) United States
(12) Patent Application Publication
(10) Pub. No.: US 2009/0116533 A1
(43) Pub. Date: May 7, 2009

(54) Method and apparatus for testing and evaluating machine components under simulated in-situ thermal operating conditions

(75) Inventors: Matthew J. O'Connell, Taylors, SC (US); Christopher E. Thompson, Danvers, MA (US); Paul S. Dimascio, Greet, SC (US)

Correspondence Address: NIXON & VANDERHYE, PC, 901 NORTH GLEBE ROAD, 11TH FLOOR, ARLINGTON, VA, 22203, US

(73) Assignee: GENERAL ELECTRIC COMPANY, Schenectady, NY (US)

(21) Appl. No.: 11/979,431

(22) Filed: Nov. 2, 2007

(51) Int. Cl. G01N 25/72; G01N 29/14; G01N 19/08

(52) U.S. Cl. 374/5; 73/587; 73/799

(57) ABSTRACT

A method and apparatus is described for enabling the testing and evaluation of industrial machine components and, in particular, gas turbine engine components, under simulated in-situ thermal operating conditions for effectively evaluating new component designs and repair techniques. A specimen machine component/part is placed in a test chamber and cyclically heated and cooled while being monitored to obtain information regarding the initiation and propagation of a crack within the structure of the component. Information regarding the number of heating and cooling cycles sustained by the component until crack initiation and information indicating the rate of crack propagation are acquired and compared over multiple heating-cooling cycles to evaluate components and repair techniques. In one example implementation, the component is monitored during cyclic heating-cooling for spontaneous acoustic emissions and acoustic emission waveform data is recorded and analyzed to determine crack initiation and/or propagation.

### BACKGROUND OF THE INVENTION

The subject matter disclosed herein relates generally to a method and apparatus for testing and evaluating new or repaired machine components to obtain data on crack initiation and propagation, and more particularly, to a method and apparatus for testing and evaluating new and repaired turbine engine components subjected to cyclical thermal stresses to obtain data on crack initiation and propagation.

In the field of gas turbine engine design and repair engineering, it is highly desirable to be able to accurately evaluate new mechanical/structural designs of turbine engine components as well as reliably validate new or different component repair techniques before implementing such in the field. It is also known that effective evaluation of the structural integrity and durability of a new component design or of a repaired machine component is based at least in part upon obtaining accurate information on the initiation and propagation of cracks that may occur within the component when subjected to the stresses incurred during actual operating conditions. As with many industrial and commercial machine components, and in particular with gas turbine engine components, one preeminent factor in the formation of cracks within a component is the repetitive thermal stresses to which the component may be subjected during use. In the past, there was no simple, inexpensive and accurate method or apparatus available for testing and evaluating individual parts or components of turbine engines under actual thermal operating conditions to obtain accurate and reliable crack initiation and propagation data. Conventionally, methods for predicting the potential success of a new part/component design or component repair procedure/technique typically entail evaluating a particular component in-situ under actual operating conditions either by performing a comprehensive full operational test of a particular individual turbine engine or by performing a so called “fleet leader” test either of which can take a very long time to perform and both of which are fairly expensive to implement. Consequently, there is a need for a convenient, inexpensive and accurate method and apparatus for testing and evaluating individual turbine engine components and/or other large/complex industrial machine components under the thermal stresses of actual operating conditions without the need for subjecting a particular machine or turbine engine to the testing procedures.

### BRIEF DESCRIPTION OF THE INVENTION

A method and apparatus is disclosed for the monitoring of industrial machine components under simulated in-situ thermal operating conditions to obtain information on crack initiation and propagation within the component for evaluating new designs and repair techniques. In particular, an example method and apparatus is disclosed for examining, testing and evaluating individual turbine engine parts/components, as well as repaired parts/components, under simulated in-situ thermal operating conditions. In one non-limiting example implementation disclosed herein, a specimen component or machine part is placed in a heating chamber filled with an inert gas and then cyclically heated and allowed to cool while being monitored for acoustic emissions. An in-situ temperature profile for a specific component is developed based on predicted in-service operating conditions for that particular component. This predetermined temperature profile is used to control cycles of heating and cooling so as to simulate, at least in part, actual thermal operating conditions for the part/component within a particular machine, engine or system in which the component is used. The cyclical heating-cooling of the specimen component is continued until a crack develops in the component structure. Acoustic emissions occurring during the heating-cooling cycles and the number of heating-cooling cycles required to initiate a crack in the specimen component are monitored, recorded and analyzed to provide information regarding thermally induced stresses and the initiation and propagation of cracks. Information concerning the propagation and growth rate of cracks developed in a particular component may also be obtained by further monitoring and analyzing the acoustic emission waveforms and tracking heating-cooling cycles required to propagate an induced crack to a predetermined length.

In addition to or in place of using acoustic emissions to obtain information regarding the number of heating-cooling cycles required to initiate and/or propagate a crack in a machine component as discussed above, any one of a variety of other known conventional inspection/non-destructive examination (NDE) techniques may also be used. For example, any of a variety of well known conventional materials examination/inspection techniques, such as fluorescent/liquid penetrant inspection (FPI/LPI), ultrasonic inspection, eddy current inspection, magnetic-particle inspection, FLIR camera inspection, and/or visual inspection may be employed for detecting/observing crack initiation and monitoring crack propagation.

At least one aspect of the example method and apparatus disclosed herein is its application in the evaluation and validation of new/different repair techniques. In this application, after an initial phase of examination while inducing the development of a crack, the component is repaired using conventional or newly developed repair techniques and then subjected again to the repeated/cyclic heating-cooling and acoustic monitoring process until crack initiation and propagation re-occurs. In this manner, information regarding the number of thermal cycles endured by the component until crack initiation both prior to repair and after repair, the rate of crack propagation as well as the acoustic waveform data acquired from multiple test repetitions may be compared and used, among other things, to effectively evaluate proposed new repair techniques as well as new component designs.

In at least one aspect, the non-limiting example implementation disclosed herein provides a novel method and apparatus for evaluating new machine components and validating component repairs through the combination of a programmable cyclic thermal stress testing apparatus for simulating actual in-situ thermal operating conditions of a machine component combined with acoustic emission monitoring and analysis of the tested component.

Another aspect of the non-limiting exemplary implementation described herein is the provision of a gas turbine engine part/component testing apparatus and method capable of simulating in-situ thermal operating conditions of the component for evaluating and validating new component geometries, designs as well as component repair techniques without necessitating the labor and expense of conducting a full turbine engine test to test a single component.

Yet another aspect of the non-limiting example test apparatus and method implementation described herein is the provision of an alternative means for analyzing turbine engine component designs and repairs under actual thermal operational conditions for a particular machine.

A further aspect of the non-limiting exemplary implementation disclosed herein is the provision of a method and apparatus for testing and evaluating machine components of various geometries under in-situ thermal conditions in a relatively expeditious and inexpensive manner.

Yet a further aspect of the non-limiting example implementation disclosed herein is automation of the machine component testing process so that it may be conducted over long periods of time and over many thermal “cycles” without the need for human intervention.

Yet a further aspect of the exemplary implementation disclosed herein is that crack initiation and propagation information is acquired with a higher degree of confidence than conventional testing methods, and is done so without subjecting the actual machine in which the component functions to a full operational test.

Yet still another aspect of the non-limiting example test apparatus and method implementation described herein is an ability to replicate the in-service conditions and environment of a variety of machine components so as to enable providing a simple, inexpensive and accurate method for evaluation of the effectiveness of new component designs or component repair technique.

Yet still another aspect of the non-limiting example test apparatus and method implementation described herein is the potential for implementing a crack initiation and propagation test method which, through the use of forced heating and/or forced cooling cycles, can effectively simulate engine operation cycles and perform aggressive testing in an accelerated fashion over a shorter period of time.

### BRIEF DESCRIPTION OF THE DRAWINGS

FIG. 1 is a schematic block diagram illustrating a functional overview of an example implementation of a system for testing and evaluating machine components using cyclic heating and acoustic emission monitoring under simulated in-situ thermal operating conditions; and

FIG. 2 shows a cut-away perspective view of an example non-limiting illustrative implementation of a system and apparatus for cyclically heating turbine machine components and monitoring acoustic emissions.

### DETAILED DESCRIPTION OF THE INVENTION

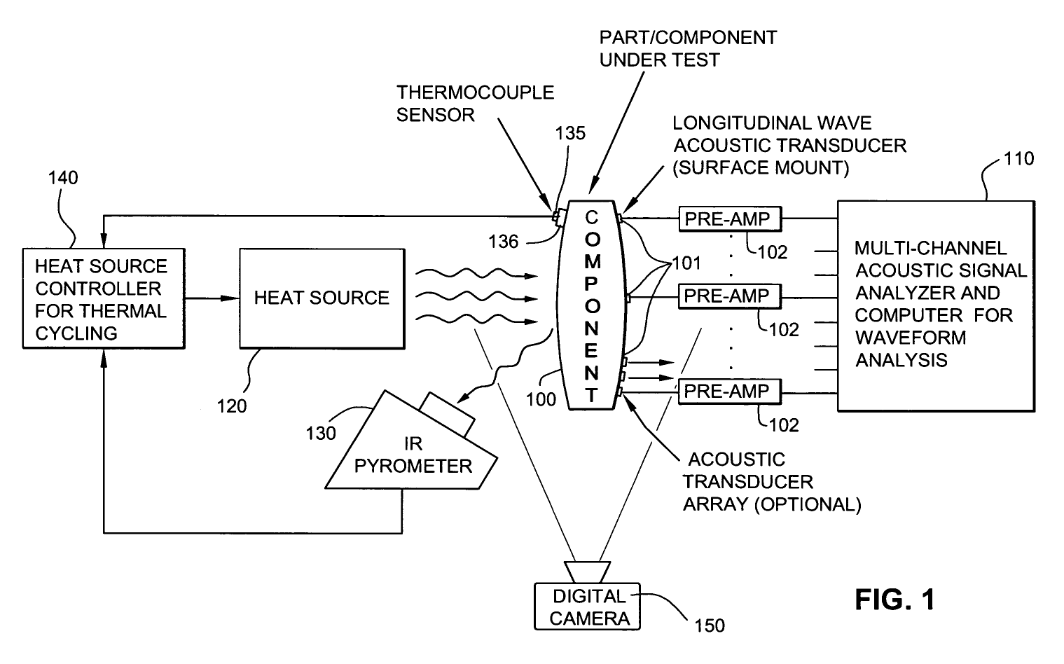

FIG. 1 is a basic functional block diagram for a exemplary implementation of a system that combines cyclic heating and/or cooling with acoustic emission monitoring for the purpose of testing and evaluating an individual machine component (i.e., a specimen component) under simulated in-situ thermal operating conditions. In the non-limiting example implementation disclosed herein, the energy and amplitude of spontaneously occurring acoustic “hits” (i.e., sonic or vibrational emissions greater than a predetermined threshold or amplitude) detected during a repeated cycle of heating a machine component, then allowing it to cool off, are recorded and analyzed for the purpose of obtaining data on the initiation and propagation of cracks in the component's structure, among other things. The number of heating-cooling cycles required to initiate a crack and/or the number of heating-cooling cycles needed to propagate a crack to a predetermined size/distance within the tested component are also noted and/or recorded. During each heating and cooling cycle, the temperature of a heated component 100 is monitored and heating is maintained in accordance with a predetermined temperature profile. In the non-limiting example implementation disclosed herein, the predetermined temperature profile is one that emulates actual in-situ working conditions within a particular machine. The predetermined temperature profile is followed and closely maintained through the use of an independent heat source 120 and a heat source controller 140 that monitors the temperature of the specimen component and controls heating, cool down time and heating cycle duration. An infrared (IR) pyrometer 130 or one or more other thermo-couple temperature sensing devices 135 placed in contact with the component is used to provide component temperature information to heat source controller 140. If very sensitive thermo-couple devices are used, a mounting bracket or other support platform 136 may be welded or clamped onto the specimen component (where appropriate) to provide some thermal resistance to mitigate the possibility of damage or inaccuracy of the sensor due to over-heating.

In addition to providing a heat source to induce accelerated heating, an appropriate heat-sinking or temperature reducing/cooling source may also be used in conjunction or in place of heating source 120 to provide accelerated cooling. Controller 140 is used to control and regulate temperature and to cycle both heating and cooling sources either individually, in concordance or in a predetermined sequence to perform an aggressive testing of the component in an accelerated fashion over a shorter period of time. A variety of conventional techniques and equipment may be used to implement the accelerated cooling such as, for example, cooled forced air-flow, dry ice, liquid nitrogen, etc.

The particular non-limiting example implementation disclosed herein uses the combination of a thermal cycling oven and conventional acoustic emission analyzing equipment to simulate and analyze the effects of thermal stresses produced during multiple turbine engine trips (i.e., multiple full-stop to full-load and back to full-stop cycles) will have on the integrity of a particular turbine engine component or repaired component. Referring first to FIG. 1, a specimen component 100 (e.g., a new part/component model or repaired part to be tested) is outfitted with one or more longitudinal-wave acoustic transducers 101 affixed to its surface. Acoustic transducers 101 detect sound vibrations emanating from component 100 as it is thermally cycled through a predetermined heating-cooling temperature profile by heat source 120 and controller 140. The energy and amplitude of spontaneous vibrations or acoustic emissions that are above a predetermined threshold are detected and recorded throughout a plurality of heating and cooling cycles to document any changes that may occur in the component's structural integrity over multiple thermal cycles for comparison and analysis. More specifically, the waveforms of the acoustic emissions obtained from the specimen component provide information indicative of stretching vibrations, phase changes, crack initiation and crack propagation, among other things, that may occur within the specimen component when subjected to thermal stresses during the heating-cooling cycles. In particular, certain detected acoustic emissions have uniquely identifiable waveforms that are specifically indicative of crack initiation and crack propagation processes that take place within a component.

As shown in FIG. 1, electrical signals from one or more transducers 101 are provided to a conventional multi-channel acoustic signal analyzer 110 throughout each heating-cooling cycle. A means for pre-amplification/filtering 102 of the signals received from transducers 101 may also be provided to improve signal strength and signal-to-noise ratio. Multi-channel acoustic signal analyzer 110 may incorporate a computer internally or operate in conjunction with a conventional desktop or laptop computer that is configured to perform acoustic signal waveform analysis for identifying crack initiation and propagation and/or comparing different acoustic waveform signals obtained from transducers 101. One example of a conventional multi-channel acoustic signal analyzer which may be used in a suitable implementation is the Micro DiSP-8 acoustic emission analyzer manufactured by Physical Acoustics Corporation of Princeton Junction, N.J.

A variable temperature controllable heat source 120 is provided for heating component 100 to temperatures which emulate predetermined in-situ operational conditions. Heat source 120 may be any number or combination of conventional heating devices that are controllable over a desired range of temperatures such as, for example, an electrical induction heating coil, a radiant quartz heating lamp or an electrical resistance heater. An appropriate heat source controller 140 is used for controlling heat source 120 to produce multiple heating and cooling cycles that follow the predetermined temperature profile over each cycle. An Infrared pyrometer 130 is used to provide a temperature feedback signal to heat source controller 140 for monitoring the temperature of component 100 and controlling the output of heat source 120 throughout each cycle of heating and cooling. Alternatively, a thermocouple sensor 135 or other temperature sensing device may be used to provide a temperature feedback signal to heat source controller 140.

In one example implementation of the machine component testing and evaluation method disclosed herein, heating and cooling of specimen component 100 is repeated cyclically until a crack develops within the component. Initiation and propagation of the crack can be determined by analyzing acoustic emission signals obtained from one or more acoustic transducers as discussed above. Moreover, if multiple transducers are used as an array and positioned on the surface of component 100 in relative proximity 101, the precise location of a crack may also be determined by analyzing, for example, temporal delays or phase shifts in the signals received from respective transducers forming the array. In addition to using detected acoustic emissions from within the component to track crack location and propagation, a digital camera 150 may be also used as a visual inspection tool to obtain further information of crack formation and propagation. Moreover, any one of a variety of different known conventional material inspection techniques may be used in place of acoustic emissions analysis to monitor for crack initiation and/or observe crack propagation such as, for example, fluorescent/liquid penetrant inspection (FPI/LPI), ultrasonic inspection, eddy current inspection, magnetic-particle inspection, and/or FLIR camera inspection.

As mentioned above, at least one additional aspect of the machine component testing and evaluation method disclosed herein is its use as a tool for component repair development and validation. In the non-limiting exemplary component repair validation method disclosed herein, a machine part/component is cyclically heated and cooled until a crack develops, the cracked part/component is then repaired (e.g., via a conventional welding process), and then the repaired part/component is re-tested under the same conditions which initially induced the crack or conditions replicating actual in-situ operation. The quantitative number of heating and cooling cycles required to initiate and propagate another crack within the repaired component to a predetermined crack length is recorded and compared to data acquired during similar testing conditions of the component prior to the repair.

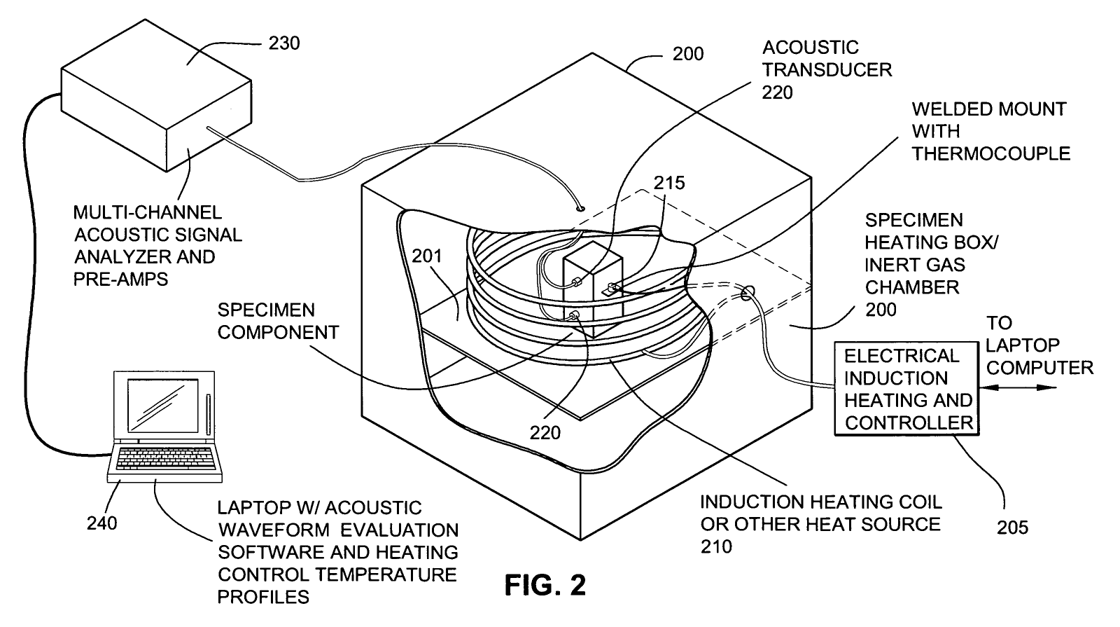

As mentioned above, a temperature cycling profile for heating and cooling a particular component to predicted service conditions is predetermined for a specific component being tested/analyzed. This temperature profile is more precisely obtained and maintained by using some sort of insulated enclosure or housing containing an internal heat source (such as quartz heating lamps, induction coils, resistance furnaces, etc.) and a stage for supporting the specimen component. For example, FIG. 2 shows a non-limiting example implementation having a specimen heating box/chamber 200 that functions as an insulated enclosure and component test support structure. In this particular example, a conventional electrical induction heating arrangement having an induction heating coil element 210 mounted within heating box/chamber 200. Preferably, induction coil 210 is of sufficiently large diameter to allow easy placement of different machine parts/components having various geometries within its center.

In the non-limiting example implementation disclosed herein, thermo-couple device 215 provides the specimen component 100 temperature information to a separate programmable heating system controller 205. Alternatively, thermo-couple 215 may provide a temperature signal directly to computer 240 which may be used with induction heating controller 205 to control heating of component 100 or computer 240 may used as a programmable heating source controller to monitor and control the heating and cooling cycles. Heating box/chamber 200 also includes some sort of specimen support stage/table 201, and is filled with an inert gas (e.g., to prevent oxidation damage to the specimen component during heating). Although the particular example implementation of FIG. 2 employs electrical inductive heating, other forms or methods of forced heating and/or cooling of a specimen component may also be used, such as, for example, quartz heating lamps, resistance furnace or other heating/cooling means or arrangements that are appropriate for and capable of heating/cooling the particular type of machine component being tested to at least predicted in-situ operating temperatures. For example, as mentioned above, a temperature reducing/cooling source may also be used or placed within chamber 200 which to operate in conjunction with, or in place of, heating source 120 in order to provide controlled cooling as well as controlled heating. Controller 140 may be used to control and regulate both the heating and cooling equipment and the heating/cooling cycles either separately or in some predetermined combination to perform accelerated and/or aggressive testing in a shortened period of time. Conventional techniques and equipment may be used to implement the forced cooling such as, for example, cooled forced air-flow, dry ice, liquid nitrogen, etc.

As illustrated in FIG. 2, a specimen component 100 is outfitted with one or more surface-mounted longitudinal wave acoustic transducers 220. If needed, one or more of the transducers may be mounted upon a bracket or other support platform 136 that is welded or clamped to the component to During heating and cooling cycles, detected acoustic and vibrational emission signals from transducers 220 are provided to multi-channel acoustic analyzer 230. A laptop computer (or other appropriate computer) 240 operates in conjunction with acoustic analyzer 230 to record the acoustic emission signals, perform waveform analysis and compare detected signals with information obtained during previous test cycles. Computer 240 is provided with conventional acoustic waveform analysis software such as, for example, that provided by Physical acoustics Corporation for the Micro DiSP-8 analyzer. Computer 240 may also used to control the electrical induction heating system 205 to ensure that the heating and cooling cycles conform to a predetermined temperature profile.

This written description uses examples to disclose the invention, including the best mode, and also to enable any person skilled in the art to practice the invention, including making and using any devices or systems and performing any incorporated methods. In particular, as mentioned above, an alternate implementation of the invention may employ any one or combination of a variety of known conventional techniques and equipment to provide accelerated heating and/or cooling of the examined component such as, for example, radiant heating lamps, electrical induction heating, electrical resistance heating, forced cooled air-flow, dry ice, liquid nitrogen, etc. Likewise, any of a variety of different known conventional material inspection techniques may be used in place of an acoustic emissions analysis to monitor for crack initiation and/or observe crack propagation such as, for example, fluorescent/liquid penetrant inspection (FPI/LPI), ultrasonic inspection, eddy current inspection, magnetic-particle inspection, FLIR camera inspection, and/or visual inspection.

The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of examining a machine component under simulated in-situ thermal operating conditions, comprising the steps of:
heating a machine component then allowing it to cool in a repeating cyclic manner in accordance with a predetermined temperature profile that simulates, at least in part, in-situ thermal working conditions of the component within a particular machine, wherein cyclic heating-cooling is continued until a crack develops within said component;
examining the component throughout a plurality of heating-cooling cycles to detect genesis of a crack within the component; and
determining a first numeric quantity of heating-cooling cycles required to initiate said crack in the component.

2. The method according to claim 1, wherein said heating-cooling cycles are implemented using one or more of the following techniques or equipment: electric radiant heating lamps, electrical induction heating, electrical resistance heating, cooled forced air-flow, dry ice or liquid nitrogen.

3. The method according to claim 1, wherein said examining step is performed to monitor for crack initiation and/or to observe crack propagation, and includes any one or more of the following material inspection techniques: fluorescent/liquid penetrant inspection (FPI/LPI), ultrasonic inspection, eddy current inspection, magnetic-particle inspection, FLIR camera inspection, acoustic emission inspection and/or visual inspection.

4. A method of examining a machine component under simulated in-situ thermal operating conditions, comprising the steps of:
heating a machine component then allowing it to cool in a repeating cyclic manner in accordance with a predetermined temperature profile that simulates, at least in part, in-situ thermal operating conditions of the component within a particular machine, wherein cyclic heating-cooling is continued until a crack develops within said component;
monitoring acoustic emissions generated within the component during a plurality of heating-cooling cycles;
identifying an acoustic emission waveform indicative of crack initiation within the component; and
determining a first numeric quantity of heating-cooling cycles required to initiate said crack in the component.

5. The method according to claim 4, further including the steps of:
identifying an acoustic emission waveform indicative of crack propagation within said component;
determining from said acoustic emission waveform indicative of crack propagation when a crack propagation length has reached a predetermined size; and
determining a further numeric quantity of heating-cooling cycles required to produce a propagation length of said predetermined size in said component.

6. The method according to claim 4, wherein said monitoring step includes placing one or more transducers on a surface of the component, said transducers being responsive to sound and/or vibrations originating from said component for generating an acoustic waveform signal.

7. The method of claim 6, wherein at least one transducer is a longitudinal wave transducer.

8. The method of claim 6 wherein said one or more transducers are mounted upon an insulating platform that is welded or clamped to the component.

9. The method according to claim 4, wherein said monitoring step further includes positioning an array of transducers on a surface of the component, said transducers being responsive to sound and/or vibrations; and
analyzing a plurality of acoustic waveform signals obtained from the array of transducers to detect a location of said crack developed within the component.

10. The method according to claim 4, wherein said heating step includes monitoring a temperature of the component and controlling a heating of the component so as to follow a predetermined temperature versus time heating profile.

11. The method according to claim 4, wherein the component is heated within an enclosure filled with an inert gas.

12. The method according to claim 4, wherein a programmable heat source controller is used to control heating-cooling cycles.

13. The method according to claim 4, wherein the component is heated through use of electrical induction.

14. The method according to claim 4, wherein the component is heated through use of a radiant energy source.

15. The method according to claim 4, wherein the component is heated within a conventional resistance furnace.

16. An apparatus for testing a machine component under simulated in-situ thermal operating conditions, comprising:
a heat generating source for heating a specimen component;
a heat source controller for cyclically controlling the heat source for heating the specimen component in accordance with a predetermined temperature versus time heating profile;
one or more transducers for mounting on a surface of the specimen component, said transducers being responsive to sound and/or vibrations originating within the specimen component for generating acoustic emission waveform signals,
a multi-channel acoustic signal analyzer for acquiring and comparing acoustic emission signal waveforms generated by said transducers, a particular acoustic emission signal waveform being indicative of crack initiation and/or crack propagation occurring within the specimen component; and
a housing for containing said heat generating source and said specimen component.

17. The apparatus of claim 16, wherein the heat generating source is an electrical induction heater.

18. The apparatus of claim 16, wherein the housing contains an inert gas.

19. The apparatus of claim 16, wherein the heat generating source is an electrical resistance heater.

20. The apparatus of claim 16, wherein the heat generating source is a quartz heating lamp.

21. The apparatus of claim 16, wherein the specimen component is a gas turbine engine component.

22. The apparatus of claim 16, wherein at least one transducer is a longitudinal wave transducer.

23. The apparatus of claim 16 further including an array of transducers positioned on a surface of the specimen component, said array of transducer providing a plurality of acoustic signals indicative of a location of a crack within said specimen component.

24. A method of evaluating crack repair in a machine component comprising:
heating a machine component then allowing it to cool in a repeating cyclic manner in accordance with a predetermined temperature profile that simulates, at least in part, in-situ thermal operating conditions of the component within a particular machine, wherein cyclic heating-cooling is continued until a crack develops within said component;
monitoring acoustic emissions generated within the component during a plurality of heating-cooling cycles;
identifying an acoustic emission waveform indicative of crack initiation within the component;
determining a first numeric quantity of heating-cooling cycles required to initiate said crack in the component;
repairing said crack induced in the component;
after a repairing of the component is complete, subjecting the component to further heating-cooling cycles while monitoring for acoustic emissions until an acoustic emission waveform indicative of a crack initiation within the component is detected;
determining a second numeric quantity of heating-cooling cycles required to initiate a crack in the repaired component; and
comparing said second numeric quantity of heating-cooling cycles required to initiate a crack in the repaired component with the first numeric quantity of heating-cooling cycles required to initiate a crack in the component prior to repairing.

25. A method of evaluating machine components under simulated in-situ thermal operated conditions, comprising:
stressing a machine component by cyclical heating and cooling until a crack is induced in the component, said cyclical heating based on a temperature profile which simulates, at least in part, in-situ thermal operating conditions of the component for a particular machine;
determining a first numeric quantity of heating-cooling cycles required to initiate crack formation within the component;
effecting a repair of said crack induced in the component;
subjecting said component after repairing of said crack to further cyclical heating and cooling until a crack is induced within the component and determining a second numeric quantity of heating-cooling cycles required to induce said crack within the component; and
comparing said first numeric quantity of heating-cooling cycles with said second numeric quantity to determine viability of a repair operation.
